(19) United States
(12) Patent Application Publication
(10) Pub. No.: US 2021/0141644 A1
(43) Pub. Date: May 13, 2021

(54) ASYNCHRONOUS PROCESSOR ARCHITECTURE

(71) Applicant: VSORA, Meudon La Foret (FR)

(72) Inventors: Khaled Maalej, Paris (FR); Trung-Dung Nguyen, Massy (FR); Julien Schmitt, Massy (FR); Pierre-Emmanuel Bernard, Antony (FR)

(21) Appl. No.: 17/255,791

(22) PCT Filed: May 21, 2019
(86) PCT No.: PCT/FR2019/051156

§ 371 Date: Dec. 23, 2020

(30) Foreign Application Priority Data
Jun. 29, 2018 (FR) 18 56000

(51) Int. Cl. G06F 9/38; G06F 9/30; G06F 7/57

(52) U.S. Cl. CPC G06F 9/3871; G06F 9/3885; G06F 7/57; G06F 9/30105; G06F 9/30043

(57) ABSTRACT

A data processing method comprising: a control unit, at least one ALU, a set of registers, a memory and a memory interface. The method comprises: a) obtaining the memory addresses of the operands; b) reading the operands from memory; c) transmitting an instruction to execute computing operations to the ALU without any addressing instruction; d) executing all of the elementary operations by way of the ALU receiving, at input, each of the operands from the registers; e) storing the data forming results of the processing operation on the registers; f) obtaining a memory address for each of the data forming a result of the processing operation; g) writing the results to memory for storage and via the memory interface, by way of the obtained memory addresses.

### CROSS-REFERENCE TO RELATED APPLICATIONS

This application is the U.S. national phase of the International Patent Application No. PCT/FR2019/051156 filed May 21, 2019, which claims the benefit of French Patent Application No. 18 56000 filed Jun. 29, 2018, the entire content of which is incorporated herein by reference.

### FIELD

The disclosure relates to the field of processors and to their functional architecture.

### BACKGROUND

Conventionally, a computing device comprises a set of one or more processors. Each processor comprises one or more processing units, or PU. Each PU comprises one or more computing units called arithmetic logic units, or ALU. In order to have a high-performance computing device, that is to say one that is fast in order to perform computing operations, it is conventional to provide a high number of ALUs. The ALUs are thus able to process operations in parallel, that is to say at the same time. The unit of time is then a computing cycle. It is therefore common to quantify the computing power of the computing device in terms of a number of operations that it is capable of performing per computing cycle.

However, a significant portion of the computing power of a computing device is consumed in order to manage memory access operations. Such a device comprises a memory assembly, itself comprising one or more memory units, each having a fixed number of memory locations at which computing data are able to be permanently stored. During the computing processing operations, the ALUs receive, at input, data from the memory units and supply, at output, data that are for their part stored on the memory units. It is then understood that, in addition to the number of ALUs, the number of memory units is another criterion that determines the computing power of the device.

The data are routed between the ALUs and the memory units, in both directions, by a bus of the device. The term “bus” is used here in its general sense of a system (or interface) for transferring data, including hardware (interface circuit) and the protocols governing the exchanges. The bus transmits the data themselves, addresses and control signals. Each bus itself also has hardware and software limits, such that the routing of the data is limited. The bus in particular has a limited number of ports on the memory unit side and a limited number of ports on the ALUs side. Thus, during a computing cycle, a memory location is accessible via the bus in a single direction (in “read” mode or in “write” mode). Furthermore, during a computing cycle, a memory location is accessible only to a single ALU.

Between the bus and the ALUs, a computing device generally comprises a set of registers and local memory units, which may be seen as memories separate from the abovementioned memory units. For ease of understanding, a distinction is drawn here between “registers”, intended to store data as such, and “local memory units”, intended to store memory addresses. Each register is assigned the ALUs of a PU. A PU is assigned a plurality of registers. The storage capacity of the registers is highly limited in comparison with the memory units, but their content is accessible directly to the ALUs.

To perform computing operations, each ALU generally has to first of all obtain the input data of the computing operation, typically the two operands of an elementary computing operation. A “read” operation on the corresponding memory location via the bus in order to import each of the two operands onto a register is therefore implemented. The ALU then performs the computing operation itself based on the data from a register and by exporting the result in the form of an item of data onto a register. Lastly, a “write” operation is implemented in order to record the result of the computing operation in a memory location. During such a write operation, the result stored on the register is recorded in a memory location via the bus. Each of the operations consumes a priori one or more computing cycles.

In known computing devices, it is common to attempt to execute a plurality of operations (or a plurality of instructions) during one and the same computing cycle, in order to reduce the total number of computing cycles and therefore to increase efficiency. Reference is then made to parallel “processing chains” or “pipelines”. However, there are often numerous mutual dependencies between the operations. For example, it is impossible to perform an elementary computing operation for as long as the operands have not been read and they are not accessible on a register for the ALU. Implementing processing chains therefore involves checking the mutual dependency between the operations (instructions), this being complex and therefore expensive.

A plurality of independent operations are usually implemented during one and the same computing cycle. Generally, for a given ALU and during one and the same computing cycle, it is possible to perform a computing operation and a read or write operation. By contrast, for a given ALU and during one and the same computing cycle, it is impossible to simultaneously perform a read operation and a write operation (in the case of single-port memory units). On the other hand, memory access operations (the bus) do not make it possible to perform read or write operations for two ALUs that are separate from one another during one and the same computing cycle and for a given memory location.

It is therefore known to perform an elementary computing operation and to write the result that is obtained to memory during one and the same computing cycle. The economy in terms of computing cycles (or computing resources) remains poor.

The disclosed embodiments improve the situation.

### SUMMARY

Disclosed is a data processing method, able to be broken down into a set of elementary operations to be performed, implemented by a computing device, said device comprising:
a control unit;
at least one arithmetic logic unit;
a set of registers able to supply data forming an operand to the inputs of said first arithmetic logic unit and able to be supplied with data from the outputs of said arithmetic logic unit;
a memory;
a memory interface by way of which data are transmitted and routed between the registers and the memory.

The method comprises:
a) obtaining the memory addresses of each of the data absent from the registers and forming an operand for at least one of said elementary operations to be performed and;
b) reading each of said data from memory by way of the obtained memory addresses in order to load them into the registers via the memory interface;
c) transmitting an instruction to execute computing operations from the control unit to said first arithmetic logic unit, said instruction not containing any addressing instruction;
d) upon receiving said instruction to execute computing operations, and as soon as the corresponding operands are available on the registers, executing all of said elementary operations by way of said first arithmetic logic unit receiving, at input, each of the operands from the registers;
e) storing the data forming results of the processing operation on the registers at output of said first arithmetic logic unit;
f) obtaining a memory address for each of the data forming a result of the processing operation;
g) writing each of the data forming a result of the processing operation from the registers to memory for storage and via the memory interface, by way of the obtained memory addresses.

Such a method makes it possible, by dissociating the tasks relating to the processing of the memory addresses and the computing tasks over time, to relieve the ALU performing the computing operations from having to furthermore perform addressing operations that would require stopping the computing operations. In doing so, the processing operation in its entirety becomes both asynchronous and self-adaptable: the elementary computing operations are initiated (by an instruction transmitted to an ALU) only once the memory addresses have been updated in the local memory units. By dissociating the two types of operation (updating the memory addresses in the local memory units, on the one hand, and computing operations, on the other hand), it is possible to reduce the processing time. In other words, for a fixed quantity of resources, the sum of the time necessary to update the memory addresses in the local memory units during a first process, and then to perform the computing operations during a second process, is less than the time necessary for the same quantity of resources to perform the entire processing operation during a single process (with on-the-fly memory address update access in the local memory units). The time saving is particularly significant in the case of iterative processing operations, which may typically be performed by way of computing loops.

According to another aspect, what is proposed is a computing device for processing data, said processing operation being able to be broken down into a set of elementary operations to be performed. The device comprises:
a control unit;
at least one first arithmetic logic unit from among a plurality;
a set of registers able to supply data forming an operand to the inputs of said arithmetic logic units and able to be supplied with data from the outputs of said arithmetic logic units;
a memory;
a memory interface by way of which data are transmitted and routed between the registers and the memory. The computing device is configured so as to:
a) obtain the memory addresses of each of the data absent from the registers and forming an operand for at least one of said elementary operations to be performed and;
b) read each of said data from memory by way of the obtained memory addresses in order to load them into the registers via the memory interface;
c) transmit an instruction to execute computing operations from the control unit to said first arithmetic logic unit, said instruction not containing any addressing instruction;
d) upon receiving said instruction to execute computing operations, and as soon as the operands are available on the registers, execute all of said elementary operations by way of said arithmetic logic unit receiving, at input, each of the operands from the registers;
e) store the data forming results of the processing operation on the registers at output of said first arithmetic logic unit;
f) obtain a memory address for each of the data forming a result of the processing operation;
g) write each of the data forming a result of the processing operation from the registers to memory for storage and via the memory interface, by way of the obtained memory addresses.

According to another aspect, what is proposed is a set of machine instructions for implementing a method as defined herein when this program is executed by a processor. According to another aspect, what is proposed is a computer program, in particular compilation computer program, comprising instructions for implementing all or part of a method as defined herein when this program is executed by a processor. According to another aspect, what is proposed is a non-transient computer-readable recording medium on which such a program is recorded.

The following features may optionally be implemented. They may be implemented independently of one another or in combination with one another:
The first arithmetic logic unit executes all of the elementary computing operations of the processing operation during consecutive computing cycles, said first arithmetic logic unit not performing any memory access operations during said computing cycles. This makes it possible to relieve the first arithmetic logic unit from any memory access operation during the elementary computing operations, and therefore to speed up the implementation of said computing operations.
At least one of the following steps comprises an iterative loop:

a) obtaining the memory addresses of each of the data absent from the registers and forming an operand for at least one of said elementary operations to be performed and;
d) upon receiving said instruction to execute computing operations, executing all of said elementary operations by way of said first arithmetic logic unit receiving, at input, each of the operands from the registers;
f) obtaining a memory address for each of the data forming a result of the processing operation.
This makes it possible to implement computing processes that are particularly fast, because they are repetitive.
The device furthermore comprises at least one additional arithmetic logic unit separate from the first arithmetic logic unit executing all of said elementary operations. The additional arithmetic logic unit implements the following:
a) obtaining the memory addresses of each of the data absent from the registers and forming an operand for at least one of said elementary operations to be performed; and
b) reading each of said data from memory by way of the obtained memory addresses in order to load them into the registers via the memory interface.
This makes it possible to distribute the functions in a fixed manner for each ALU, and therefore to improve their respective efficiency.

In parallel, the applicant also describes an approach in which, upon each read operation, the number of data read is greater than the number of data strictly necessary to implement the next computing operation. By opposition, such an approach could be called “provisional memory access”. It is then possible for one item of data from among the read data to be used for a future computing operation, other than the computing operation implemented immediately after the read operation. In such cases, the necessary data have been obtained during a single memory access operation (with an increase in the bandwidth of the memory), whereas the usual approach would have required at least two separate memory access operations. The effect of such an approach, at least in some cases, is therefore that of reducing the consumption of computing cycles for the memory access operations, and therefore it makes it possible to improve the efficiency of the device. Over the long term (a plurality of consecutive computing cycles), the number of memory access operations (in read mode and/or in write mode) is reduced.

This approach does not rule out losses: some of the data that are read and stored on a register may be lost (erased by other data then stored on the same register) even before having been used in a computing operation. However, over a large number of computing operations and computing cycles, the applicant observed an improvement in performance, including in the absence of selecting the read datasets. In other words, even in the absence of selecting the read data (or random selection), this approach makes it possible to statistically improve the efficiency of the computing device in comparison with the usual approach.

### BRIEF DESCRIPTION OF THE DRAWINGS

Other features, details and advantages will become apparent upon reading the detailed description below and on analyzing the appended drawings, in which:

FIG. 1 shows an architecture of a computing device according to an embodiment;

FIG. 2 is a partial depiction of an architecture of a computing device according to an embodiment;

FIG. 3 shows one example of a memory access operation;

FIG. 4 is a variant of the example from FIG. 3;

FIG. 5 schematically shows an operating architecture according to an embodiment; and

FIG. 6 shows a temporal breakdown of one operating example according to an embodiment.

### DETAILED DESCRIPTION

FIG. 1 shows one example of a computing device 1. The device 1 comprises a set of one or more processors 3, sometimes called central processing units or CPUs. The set of processor(s) 3 comprises at least one control unit 5 and at least one processing unit 7, or PU 7. Each PU 7 comprises one or more computing units, called arithmetic logic units 9 or ALU 9. In the example described here, each PU 7 furthermore comprises a set of registers 11. The device 1 comprises at least one memory 13 able to interact with the set of processor(s) 3. To this end, the device 1 furthermore comprises a memory interface 15, or “bus”.

In the present context, it is considered that the memory units are single-port, that is to say that the read and write operations are implemented during different cycles, in contrast to what are called “double-port” memories (more expensive in terms of surface and requiring larger dual control buses for reading and writing). As a variant, the proposed technical solutions may be implemented with what are called “double-port” memories. In such embodiments, read and write operations may be implemented during one and the same computing cycle.

FIG. 1 shows three PUs 7: PU 1, PU X and PU N. Only the structure of PU X is shown in detail in order to simplify FIG. 1. However, the structures of the PUs are analogous to one another. In some variants, the number of PUs is different. The device 1 may comprise a single PU, two PUs or more than three PUs.

In the example described here, the PU X comprises four ALUs: ALU X.0, ALU X.1, ALU X.2 and ALU X.3. In some variants, the PUs may comprise a number of ALUs different from one another and/or other than four, including a single ALU. Each PU comprises a set of registers 11, here at least one register 11 assigned to each ALU. In the example described here, the PU X comprises a single register 11 per ALU, that is to say four registers referenced REG X.0, REG X.1, REG X.2 and REG X.3 and assigned respectively to ALU X.0, ALU X.1, ALU X.2 and ALU X.3. In some variants, each ALU is assigned a plurality of registers 11.

Each register 11 is able to supply operand data to the inputs of said ALUs 9 and is able to be supplied with data from the outputs of said ALUs 9. Each register 11 is furthermore able to store data from the memory 13 obtained by way of the bus 15 through what is called a “read” operation. Each register 11 is furthermore able to transmit stored data to the memory 13 and by way of the bus 15 through what is called a “write” operation. The read and write operations are managed by controlling the memory access operations from the control unit 5.

The control unit 5 imposes the way in which each ALU 9 performs the elementary computing operations, in particular their order, and assigns each ALU 9 the operations to be executed. In the example described here, the control unit 5 is configured so as to control the ALUs 9 in accordance with a processing chain microarchitecture, such that the ALUs 9 perform computing operations in parallel with one another. For example, the device 1 has a single instructions flow and multiple data flow architecture, called SIMD for “single instructions multiple data”, and/or a multiple instructions flow and multiple data flow architecture, called MIMD for “multiple instructions multiple data”. On the other hand, the control unit 5 is furthermore designed to control the memory access operations by way of the memory interface 15 and in particular, in this case, the read and write operations. The two types of control (computing and memory access) are shown by arrows in broken lines in FIG. 1.

Reference is now made to FIG. 2, in which a single ALU Y is shown. The data transmissions are shown by arrows in unbroken lines. Since data are transmitted step-by-step, it is understood that FIG. 2 does not necessarily show a time t with simultaneous data transmissions. By contrast, in order for an item of data to be transmitted from a register 11 to an ALU 9, it is necessary for example for said item of data to be transmitted beforehand to said register 11 from the memory 13, in this case via the memory interface 15 (or bus).

In the example of FIG. 2, three registers 11, referenced respectively REG Y.0, REG Y.1 and REG Y.2, are assigned an ALU referenced ALU Y. Each ALU 9 has at least three ports, specifically two inputs and one output. For each operation, at least two operands are received, respectively by the first and the second input. The result of the computing operation is transmitted via the output. In the example shown in FIG. 2, the operands received at input originate respectively from the register REG Y.0 and from the register REG Y.2. The result of the computing operation is written to the register REG Y.1. Once it has been written to the register REG Y.1, the result (in the form of an item of data) is written to memory 13, via the memory interface 15. In some variants, at least one ALU may have more than two inputs and receive more than two operands for a computing operation.

Each ALU 9 may perform:
integer arithmetic operations on data (addition, subtraction, multiplication, division, etc.);
floating-point arithmetic operations on data (addition, subtraction, multiplication, division, inversion, square root, logarithms, trigonometry, etc.);
logic operations (two's complement, “AND”, “OR”, “Exclusive OR”, etc.).

The ALUs 9 do not directly exchange data with one another. For example, if the result of a first computing operation performed by a first ALU constitutes an operand for a second computing operation to be performed by a second ALU, then the result of the first computing operation should at least be written to a register 11 before being able to be used by an ALU 9.

In some embodiments, the data written to a register 11 are furthermore automatically written to memory 13 (via the memory interface 15), even if said item of data is obtained only to serve as operand and not as a result of a processing process in its entirety.

In some embodiments, the data obtained to serve as operand and having brief relevance (intermediate result of no interest at the end of the processing operation in its entirety) are not automatically written to memory 13, and may be stored only temporarily on a register 11. For example, if the result of a first computing operation performed by a first ALU constitutes an operand for a second computing operation to be performed by a second ALU, then the result of the first computing operation should be written to a register 11. Next, said item of data is transmitted to the second ALU as operand directly from the register 11. It is then understood that the assignment of a register 11 to an ALU 9 may evolve over time, and in particular from one computing cycle to another. This assignment may in particular take the form of addressing data that make it possible at all times to locate the location of an item of data, be this on a register 11 or at a location in the memory 15.

In the following text, the operation of the device 1 is described for a processing operation applied to computing data, the processing operation being broken down into a set of operations, including computing operations performed in parallel by a plurality of ALUs 9 during a time period consisting of a sequence of computing cycles. It is then said that the ALUs 9 are operating in accordance with a processing chain microarchitecture. However, the processing operation implemented by the device 1 and involved here may itself constitute part (or a subset) of a more global computing process. Such a more global process may comprise, in other parts or subsets, computing operations performed in a non-parallel manner by a plurality of ALUs, for example in a series operating mode or in cascade.

The operating architectures (parallel or in series) may be constant or dynamic, for example imposed (controlled) by the control unit 5. The architecture variations may for example depend on the data to be processed and on the current instructions received at input of the device 1. Such dynamic adaptation of the architectures may be implemented as early as the compilation stage, by adapting the machine instructions generated by the compiler on the basis of the type of data to be processed and the instructions when the type of data to be processed and the instructions are able to be deduced from the source code. Such adaptation may also be implemented only at the device 1, or a processor, when it executes a conventional machine code and it is programmed to implement a set of configuration instructions dependent on the data to be processed and the current received instructions.

The memory interface 15, or “bus”, transmits and routes the data between the ALUs 9 and the memory 15 in both directions. The memory interface 15 is controlled by the control unit 5. The control unit 5 thus controls access to the memory 13 of the device 1 by way of the memory interface 15.

The control unit 5 controls the (computing) operations implemented by the ALUs 9 and the memory access operations in a coordinated manner. The control by the control unit 5 comprises implementing a sequence of operations broken down into computing cycles. The control comprises generating a first cycle i and a second cycle ii. The first cycle i is temporally before the second cycle ii. As will be described in more detail in the examples below, the second cycle ii may be immediately subsequent to the first cycle i, or else the first cycle i and the second cycle ii may be temporally spaced from one another, for example with intermediate cycles.

The first cycle i comprises:
implementing a first computing operation by way of at least one ALU 9; and
downloading a first dataset from the memory 13 to at least one register 11.

The second cycle ii comprises implementing a second computing operation by way of at least one ALU 9. The second computing operation may be implemented by the same ALU 9 as the first computing operation or by a separate ALU 9. At least part of the first dataset downloaded during the first cycle i forms an operand for the second computing operation.

Reference is now made to FIG. 3. Some data, or blocks of data, are referenced respectively A0 to A15 and are stored in the memory 13. In the example, it is considered that the data A0 to A15 are grouped together in fours as follows:
a dataset referenced AA0_3, consisting of the data A0, A1, A2 and A3;
a dataset referenced AA4_7, consisting of the data A4, A5, A6 and A7;
a dataset referenced AA8_11, consisting of the data A8, A9, A10 and A11; and
a dataset referenced AA12_15, consisting of the data A12, A13, A14 and A15.

As a variant, the data may be grouped together differently, in particular in groups (or “blocks”, or “slots”) of two, three or more than four. A dataset may be seen to be a group of data accessible on the memory 13 by way of a single port of the memory interface 15 during a single read operation. Likewise, the data of a dataset may be written to memory 13 by way of a single port of the memory interface 15 during a single write operation.

Thus, during a first cycle i, at least one dataset AA0_3, AA4_7, AA8_11 and/or AA12_15 is downloaded to at least one register 11. In the example in the Figure, each of the datasets AA0_3, AA4_7, AA8_11 and/or AA12_15 is downloaded to a respective register 11, that is to say four registers 11 separate from one another. Each of registers 11 is at least temporarily assigned to a respective ALU 9, here respectively referenced ALU 0, ALU 1, ALU 2 and ALU 3. During this one and the same cycle i, the ALUs 9 may have implemented a computing operation.

During a second cycle ii, each ALU 9 implements a computing operation for which at least one of the items of data stored on the corresponding register 11 forms an operand. For example, the ALU 0 implements a computing operation for which one of the operands is A0. A1, A2 and A3 may be unused during the second cycle ii.

Generally speaking, downloading data from the memory 13 to a register 11 consumes less computing time than implementing computing operations by way of ALUs 9. It may thus generally be considered that a memory access operation (here a read operation) consumes a single computing cycle, whereas implementing a computing operation by way of an ALU 9 consumes a computing cycle or a succession of a plurality of computing cycles, for example four.

In the example of FIG. 3, there are a plurality of registers 11 assigned to each ALU 9, shown by groups of registers 11 referenced REG A, REG B and REG C. The data downloaded from the memory 13 to the registers 11 correspond to the groups REG A and REG B. The group REG C is intended here to store data obtained through computing operations implemented by the ALUs 9 (during a write operation).

The registers 11 of the groups REG B and REG C may thus contain datasets referenced analogously to those of REG A:
the group REG B comprises four registers 11 on which there are respectively stored a dataset BB0_3 consisting of data B0 to B3, a dataset BB4_7 consisting of data B4 to B7, a dataset BB8_11 consisting of data B8 to B11 and a dataset BB12_15 consisting of data B12 to B15;
the group REG C comprises four registers 11 on which there are respectively stored a dataset CC0_3 consisting of data C0 to C3, a dataset CC4_7 consisting of data C4 to C7, a dataset CC8_11 consisting of data C8 to C11 and a dataset CC12_15 consisting of data C2 to C15.

In the example of FIG. 3, the data AN and BN constitute the operands for a computing operation implemented by an ALU 9, whereas the item of data CN constitutes the result, where “N” is an integer between 0 and 15. For example, in the case of an addition, CN=AN+BN. In such an example, the data processing operation implemented by the device 1 corresponds to 16 operations. The 16 operations are independent of one another in the sense that none of the results of the 16 operations is needed to implement one of the other 15 operations.

The implementation of the processing operation (the 16 operations) may therefore for example be broken down as follows, into 18 cycles.

### EXAMPLE 1

cycle #0: read AA0_3;

cycle #1: read BB0_3;

cycle #2: compute C0 (from the set CC0_3) and read AA4_7 (forming for example a cycle i);

cycle #3: compute C1 (from the set CC0_3) and read BB4_7 (forming for example a cycle i);

cycle #4: compute C2 (from the set CC0_3);

cycle #5: compute C3 (from the set CC0_3) and write CC0_3;

cycle #6: compute C4 (from the set CC4_7) and read AA8_11 (forming for example a cycle ii);

cycle #7: compute C5 (from the set CC4_7) and read BB8_11 (forming for example a cycle ii);

cycle #8: compute C6 (from the set CC4_7) (forming for example a cycle ii);

cycle #9: compute C7 (from the set CC4_7) and write CC4_7 (forming for example a cycle ii);

cycle #10: compute C8 (from the set CC8_11) and read AA12_15;

cycle #11: compute C9 (from the set CC8_11) and read BB12_15;

cycle #12: compute C10 (from the set CC8_11);

cycle #13: compute C11 (from the set CC8_11) and write CC8_11;

cycle #14: compute C12 (from the set CC12_15);

cycle #15: compute C13 (from the set CC12_15);

cycle #16: compute C14 (from the set CC12_15);

cycle #17: compute C15 (from the set CC12_15) and write CC12_15.

It is then understood that, with the exception of the initial cycles #0 and #1, the memory access operations (read and write operations) are implemented in parallel with the computing operations, without consuming an additional computing cycle. Reading the datasets containing (a plurality of) data, or blocks of data, rather than reading a single item of data, makes it possible to end the importing of the data from the memory 13 to the registers even before said data become necessary, as operand, for a computing operation.

In the example of cycle #2 above, if only the item of data that is immediately necessary (A0) were to have been read rather than reading the set AA0_3={A0; A1; A2; A3}, then it would have been necessary to subsequently implement three additional read operations in order to obtain A1, A2 and A3.

For better understanding, and for comparison, the implementation of a processing operation in which a single item of data is read each time, rather than a dataset containing (a plurality of) data, is reproduced below. It is observed that 48 cycles are necessary.

### EXAMPLE 0

cycle #0: read A0;

cycle #1: read B0;

cycle #2: compute C0 and write C0;

cycle #3: read A1;

cycle #4: read B1;

cycle #5: compute C1 write C1;

cycle #45: read A15;

cycle #46: read B15;

cycle #47: compute C15 and write C15.

In example 1 (18 cycles), it is noted that the first two cycles #0 and #1 constitute initialization cycles. The number I of initialization cycles corresponds to the number of operands per computing operation. Next, a pattern of four successive cycles is repeated four times. For example, cycles #2 to #5 together form a pattern. The number of cycles per pattern corresponds to the number D of data per dataset, whereas the number of patterns corresponds to the number E of datasets to be processed. The total number of cycles may therefore be expressed as follows: I+D*E.

Achieving good performance is tantamount to reducing the total number of cycles to a minimum. In the conditions under consideration, that is to say 16 elementary and independent operations each able to be implemented over one cycle, the optimum number of cycles therefore appears to be equal to that number of elementary operations (16) plus the initialization phase (2 cycles), that is to say a total of 18 cycles.

In one variant, it is considered that the number of data accessible (in read mode or in write mode) in a single cycle (the number D of data per dataset) is equal to three (and not four), for example due to hardware limitations. The sequence of cycles may then for example be broken down as follows:
an initialization phase of 2 cycles; and then
5 patterns of 3 cycles for a total of 15 elementary computing operations out of the 16 to be performed; and then
a final cycle for computing and recording the result of the last elementary computing operation.

### EXAMPLE 2

cycle #0: read AA0_2={A0; A1; A2};

cycle #1: read BB0_ 2={B0; B1; B2};

cycle #2: compute C0 (from the set CC0_2={C0; C1; C2}) and read AA3_5 (forming for example a cycle i);

cycle #3: compute C1 (from the set CC0_2) and read BB3_5 (forming for example a cycle i);

cycle #4: compute C2 (from the set CC0_2) and write CC0_2;

cycle #5: compute C3 (from the set CC3_5) and read AA6_8 (forming for example a cycle ii);

cycle #6: compute C4 (from the set CC3_5) and read BB6_8 (forming for example a cycle ii);

cycle #7: compute C5 (from the set CC3_5) and write CC3_5 (forming for example a cycle ii);

cycle #8: compute C6 (from the set CC6_8) and read AA9_11;

cycle #9: compute C7 (from the set CC6_8) and read BB9_11;

cycle #10: compute C8 (from the set CC6_8) and write CC6_8;

cycle #11: compute C9 (from the set CC9_11) and read AA12_14;

cycle #12: compute C10 (from the set CC9_11) and read BB12_14;

cycle #13: compute C11 (from the set CC9_11) and write CC9_11;

cycle #14: compute C12 (from the set CC12_14) and read A15 (forming for example a cycle i);

cycle #15: compute C13 (from the set CC12_14) and read B15 (forming for example a cycle i);

cycle #16: compute C14 (from the set CC12_14) and write CC12_14;

cycle #17: compute C15 (isolated item of data) and write C15 (forming for example a cycle ii).

In example 2, it is observed that each cycle includes a memory access operation (in read mode or in write mode). It is therefore understood that, if the number D of data accessible in a single cycle is strictly less than three, then additional cycles will be necessary to perform memory access operations. The optimum of 18 cycles for 16 elementary operations will therefore no longer be achieved. However, even if the optimum is not achieved, the number of cycles remains significantly lower than the number of cycles necessary in example 0. An embodiment in which the datasets comprise two items of data exhibits an improvement over what currently exists.

In example 1, if cycles #2 and/or #3 correspond for example to a cycle i as defined above, then each of the cycles #6, #7, #8 and #9 corresponds to a cycle ii. Of course, this may be transposed from pattern to pattern. In example 2, if cycles #2 and/or #3 correspond for example to a cycle i as defined above, then each of the cycles #5, #6 and #7 corresponds to a cycle ii. Of course, this may be transposed from pattern to pattern.

In the examples described until now, in particular examples 1 and 2, the low total number of cycles is achieved in particular since a maximum number of memory access operations is implemented per dataset containing (a plurality of) data, rather than at the unit and in parallel with computing operations. Thus, for some parts of the process (for all of the parts in the optimized examples), the read operation on all of the necessary operands may be achieved even before the preceding elementary computing operation has ended. Computing power is preferably saved in order to perform a computing operation and record (write operation) the result of said computing operation in a common computing cycle (cycle #5 in example 1 for example).

In the examples, the advance reading of the operand data is implemented throughout the process (repeated from one pattern to another). The operands necessary for the computing operations performed during a pattern are automatically obtained (read) during the temporally previous pattern. It will be noted that, in degraded embodiments, the advance reading is implemented only in part (only for two successive patterns). Such a degraded mode in comparison with the above examples exhibits better results than existing methods.

In the examples described until now, it has been recognized that the data were read before serving as operands. In some embodiments, the data read in advance are read randomly, or at least independently of the future computing operations to be performed. Thus, at least some of the data read in advance from among the datasets effectively correspond to operands for subsequent computing operations, whereas other read data are not operands for subsequent computing operations. For example, at least some of the read data may be subsequently erased from the registers 11 without having been used by the ALUs 9, typically erased by other data recorded subsequently on the registers 11. Some data are therefore needlessly read (and needlessly recorded on the registers 11). However, it is enough for at least some of the data from the read datasets to effectively be operands in order to achieve a saving in terms of computing cycles, and the situation is therefore improved in comparison with what currently exists. Therefore, depending on the number of data to be processed and on the number of cycles, it is likely (in the mathematical sense of the term) that at least some of the pre-fetched data will effectively be able to be used as operand in a computing operation performed by an ALU 9 in a following cycle.

In some embodiments, the data read in advance are preselected, depending on the computing operations to be performed. This makes it possible to improve the relevance of the pre-fetched data. Specifically, in the examples with 16 elementary computing operations above, each of the 16 elementary computing operations requires, at input, a pair of operands, respectively A0 and B0; A1 and B1; ; A15 and B15. If the data are read randomly, then the two first cycles could correspond to the read operation on AA0_3 and BB4_7. In such a case, no complete operand pair is available on the registers 11 at the end of the first two cycles. Therefore, the ALUs 9 are not able to implement any elementary computing operation in the following cycle. One or more additional cycles would therefore necessarily be consumed for memory access operations before the elementary computing operations are able to start, thereby increasing the total number of cycles and being detrimental to efficiency.

Counting the chance and the probabilities of the data obtained in read mode being as relevant as possible is enough to improve what currently exists, but is not fully satisfactory. The situation is able to be further improved.

Implementing a prefetch algorithm makes it possible to obtain all of the operands of the next computing operation to be performed as early as possible. In the above example, reading AA0_3 and BB0_3 during the first two cycles makes it possible for example to make all of the operands necessary to implement 4 first elementary computing operations available on the registers 11.

Such an algorithm receives, as input parameters, information data relating to the computing operations to be performed subsequently by the ALUs 9, and in particular relating to the necessary operands. Such an algorithm makes it possible, at output, to select the data read (per set) in anticipation of future computing operations to be performed. Such an algorithm is for example implemented by the control unit 5 when controlling memory access operations.

According to a first approach, the algorithm imposes organization of the data as soon as they are recorded in the memory 13. For example, the data for which it is desired to form a dataset are juxtaposed and/or ordered such that the entire dataset is able to be called by a single request. For example, if the addresses of the data A0, A1, A2 and A3 are referenced respectively @A0, @A1, @A2 and @A3, then the memory interface 15 may be configured, in response to a read request on @A0, so as to automatically also read the data at the following three addresses @A1, @A2 and @A3.

According to a second approach, the prefetch algorithm provides, at output, memory access requests that are adapted on the basis of the computing operations to be performed subsequently by the ALUs 9, and in particular relating to the necessary operands. In the above examples, the algorithm identifies for example that the data to be read as a priority are those of AA0_3 and BB0_3 in order to enable, as early as the following cycle, the elementary computing operations giving the result CC0_3, that is to say computing C0 with the operands A0 and B0, computing C1 with the operands A1 and B1, computing C2 with the operands A2 and B2 and computing C3 with the operands A3 and B3. The algorithm therefore provides, at output, memory access requests that are constructed so as to generate the read operation on AA0_3 and BB0_3.

The two approaches may optionally be combined with one another: the algorithm identifies the data to be read and the control unit 5 deduces therefrom memory access requests at the memory interface 15 in order to obtain said data, the requests being adapted on the basis of the features (structure and protocol) of the memory interface 15.

In the above examples, in particular examples 1 and 2 hereinabove, the number of ALUs assigned to the elementary computing operations is not defined. A single ALU 9 may perform all of the elementary computing operations, cycle by cycle. The elementary computing operations to be performed are also able to be distributed over a plurality of ALUs 9 of a PU, for example four. In such cases, coordinating the distribution of the computing operations over the ALUs with the technique of grouping together the data to be read in each read operation may make it possible to further improve efficiency. A distinction is made between two approaches.

In a first approach, the data read in an operation form operands in computing operations implemented by just one and the same ALU 9. For example, the groups AA0_3 and BB0_3 of data A0, A1, A2, A3, B0, B1, B2 and B3 are read first and a first ALU is made responsible for computing CC0_3 (C0, C1, C2 and C3). The groups AA4_7 (A4, A5, A6, A7) and BB4_7 (B4, B5, B6 and B7) are then read, and a second ALU is made responsible for computing CC4_7 (C4, C5, C6 and C7). It is then understood that the first ALU will be able to start implementing the computing operations before the second ALU is able to do the same, since the operands necessary for the computing operations of the first ALU will be available on the registers 11 before the operands necessary for the computing operations of the second ALU are. The ALUs 9 of a PU then operate in parallel and asynchronously.

In a second approach, the data read in an operation form operands in computing operations each implemented by different ALUs 9, for example four. For example, two groups of data including respectively A0, A4, A8 and A12; B0, B4, B8 and B12 are read first. A first ALU is made responsible for computing C0, a second ALU is made responsible for computing C4, a third ALU is made responsible for computing C8 and a fourth ALU is made responsible for computing C12. It is then understood that the four ALUs will be able to start implementing their respective computing operation substantially simultaneously, since the necessary operands will be available on the registers 11 at the same time as they are downloaded in a common operation. The ALUs 9 of a PU operate in parallel and synchronously. Depending on the types of computing operations to be performed, the accessibility of the data in memory and the available resources, one or the other of the two approaches may be preferred. The two approaches may also be combined: the ALUs may be organized into subgroups, the ALUs of a subgroup operating synchronously and the subgroups operating asynchronously with respect to one another.

In order to impose synchronized, asynchronous or mixed operation of the ALUs, the grouping together of the data to be read per read operation should be selected so as to correspond to the distribution of the assignments of the computing operations to various ALUs.

In the above examples, the elementary computing operations are independent of one another. The order in which they are performed therefore does not have any importance a priori. In some applications for which at least some of the computing operations are dependent on one another, the order of the computing operations may be specific. Such a situation typically arises in the context of recursive computing operations. In such cases, the algorithm may be configured so as to identify the data to be acquired (read) as a priority. For example, if:
the result C1 is obtained through a computing operation of which one of the operands is C0, C0 itself being obtained from the operands A0 and B0,
the result C5 is obtained through a computing operation of which one of the operands is C4, C4 itself being obtained from the operands A4 and B4,
the result C9 is obtained through a computing operation of which one of the operands is C8, C8 itself being obtained from the operands A8 and B8, and
the result C13 is obtained through a computing operation of which one of the operands is C12, C12 itself being obtained from the operands A12 and B12,
   then the algorithm may be configured so as to read, during the first two initialization cycles #0 and #1, the datasets defined as follows:
{A0; A4; A8; A12}, and
{B0; B4; B8; B12}.

The dataset thus defined is shown in FIG. 4. Figuratively, it may be stated that the data are grouped together “in rows” in the embodiment shown in FIG. 3 and grouped together “in columns” in the embodiment shown in FIG. 4. Implementing the algorithm thus makes it possible to read the operands useful for the priority elementary computing operations and to make them available on the registers 11. In other words, implementing the algorithm makes it possible to increase the short-term relevance of the read data in comparison with a random read operation.

The examples of processing units and methods that are described above, merely by way of example, should not be considered limiting, and other variants may be contemplated by a person skilled in the art within the scope of protection that is sought. The examples may also take the form of:
a set of processor-implementable machine instructions for obtaining such a computing device,
a processor or a set of processors,
the implementation of such a set of machine instructions on a processor,
the processor architecture management method implemented by the processor,
the computer program comprising the corresponding set of machine instructions, and
the recording medium on which such a set of machine instructions is computationally recorded.

Reference is now made to FIG. 5. This shows one example of an operating architecture of a device 1 in which the memory access and addressing processing operations are treated separately from the elementary computing operations. Such an architecture may take the form of a computing method. It may optionally be combined with the embodiments described above. Numerical references in common with those in the previous Figures denote analogous elements, in particular a control unit 5, an ALU 9, registers 11, a memory 13 and a memory interface 15, or “bus”.

For ease of understanding, the same naming conventions are used: consideration is given to an elementary operation, for example an addition, in which AX and BX are data forming operands in order to obtain an item of data forming a result CX, where X is an integer between 0 and N, N+1 being the number of elementary operations to be performed during a processing operation. The set of N+1 operations forms the data processing operation in its entirety. Furthermore, the memory addresses of each of the data are referenced by their name preceded by the character “@” (at sign). For example, the address of the item of data A0 is denoted “@A0”.

For each addition (each value of X), a set of instructions may be implemented by the computing device 1. One example of such a set of instructions is given at the end of the description in the form of a computer pseudocode. Normally, such instructions are applied in succession during a common process implemented by an ALU 9. In the embodiments below, the instructions relating to the memory access operations and the instructions relating to the elementary computing operations are processed by processes that are separate from one another.

In one embodiment of a computing method according to FIG. 5, the method may be broken down into steps respectively referenced 101 to 109.

In steps 101 and 102, the memory addresses @A0 to @AN, respectively @B0 to @BN, of each of the data forming an operand for at least one of the elementary operations to be performed are obtained. “Obtained” is understood to mean that, at the end of operations 101 and 102, one or more local memory units store the addresses of all of the data forming an operand. Such memory access operations are for example triggered by the reception of instructions from the control unit 5. In some cases, at least some of said addresses are already stored in the local memory units. No memory access operation is therefore necessary at this stage in order to obtain said addresses previously installed on the local memory units.

In the example described here, a distinction is made between step 101, relating to the first operands “A” of the addition, and step 102, relating to the second operands “B” of the addition. Distinguishing between the two operands then makes it possible to implement iterative loops (in the computing sense) specific to each of the two operands, and possibly different from one another.

As a variant, in particular when the two operands exist beforehand at the start of the method, steps 101 and 102 may be implemented at least partly in parallel with one another, independently of one another.

In steps 103 and 104, each of said obtained data, respectively A0 to AN and B0 to BN, is read from memory 13, in order to be loaded into the registers 11, via the memory interface 15. Such read operations are made possible by virtue of the addresses obtained in steps 101 and 102. In the example described here, step 103 relates to the first operands “A”, whereas step 104 relates to the second operands “B”.

In step 105, an instruction to execute computing operations is transmitted from the control unit 5 to an ALU 9. The execution instruction is constructed so as to trigger the implementation of the elementary computing operations of the processing operation by the ALU 9. The instruction in this case does not contain any addressing instruction. Not containing any addressing instruction is understood here to mean that, in contrast to what takes place normally, the instruction to execute computing operations transmitted by the control unit 5 is not contained in a general set of instructions combining both the addressing instructions and the instructions to execute computing operations. Thus, upon receiving the instructions, the ALU 9 is able to immediately apply the instructions by performing the elementary computing operations, without it being necessary to apply beforehand any instructions to configure the memory interface 15 and therefore without it being necessary either to check any mutual dependency between the various received instructions. Figuratively, the ALU 9 then behaves as a computing resource implementing the computing operations (step 106 described below) independently of any complexity in terms of interdependence between the various instructions. By making the transmission of the computing instruction (step 105) conditional on the prior execution of the addressing operations (steps 103 and 104), the availability of the data forming operands on the registers 11 is guaranteed. In practice, the registers 11 behave as first-in first-out (or FIFO) buffer memories. The registers 11 are filled and emptied in accordance with the order of arrival of the data, here the operands AN (step 103) and BN (step 104). Step 106 is executed if the registers 11 are not empty: the registers 11 are destacked from the operands AN and BN. As a variant, the registers 11 do not operate in FIFO mode. In this case, data may be stored therein more permanently without risking being erased, and may be subsequently reused if necessary.

In step 106, upon receiving the instruction to execute computing operations, the ALU 9 executes all of the corresponding elementary operations, as soon as the operands are available on the registers 11. Step 106 therefore includes receiving, at input of the ALU 9, each of the operands from the registers 11. Under the proviso that the addressing operations 103, 104 have been correctly performed beforehand, step 106 may not involve any memory access operation (in read mode).

In step 107, the data forming results of the processing operation are stored on the registers 11 at output of the ALU 9. Only the results of the processing operation are mentioned here, and not the results of each of the elementary computing operations. Specifically, if some of the results of the elementary computing operations are used as operands for other elementary computing operations in step 107, such (intermediate) results may become needless at the end of the processing operation. In these cases, the intermediate results may be erased from the registers 11 at the end of step 107 (for example erased by other data, FIFO mode). As a variant, all of the data forming results of the elementary operations are stored on the registers 11 at the end of step 107 (mode other than FIFO).

In step 108, a memory address @CX for each of the data CX forming a result of the processing operation is obtained. Such an addressing operation makes it possible to determine the memory location at which each of the data forming a result will be stored. In the example described here, step 108 is implemented after step 107 of writing the results to the registers 11 and before writing the results to memory 13 (step 109 described below). As a variant, step 107 may be implemented earlier during the method, in particular before step 106. Specifically, in particular when the form (in particular the size) of the result data is known in advance, it is possible to address the result data even before they are computed. Obtaining the memory addresses @CX may include transmitting addressing instructions from the control unit 5.

In step 109, each of the data forming a result of the processing operation is written to memory 13 from the registers 11, for storage and via the memory interface 15, by way of the memory addresses obtained in step 108.

FIG. 6 gives some exemplary implementations of steps 101, 102, 106 and 108 in the form of computer pseudocode. Such non-limiting examples represent operations in the form of computing loops. The use of loops is particularly advantageous in order to limit the number of computing cycles that are necessary, and therefore to improve efficiency, when the operations to be implemented are substantially analogous to one another (for example all additions) and only the input data vary. In such cases, the computing instructions transmitted in step 105 may take the form of a loop that is reiterated for each operation.

The temporal order of steps 101, 102, 106 and 108 is represented by the arrow “t” in FIG. 6. Such an order constitutes one non-limiting example. FIG. 6 illustrates that, in contrast to use in the technical field, the addressing of the input data (operands) is implemented separately from the computing operations themselves. In other words, the addressing and the computing operation are processed as two processes that are separate from one another, rather than being processed indiscriminately, on-the-fly, when general instructions are received. In particular, step 106 of executing the elementary operations may start even when all of the operands have not yet been downloaded from the memory 13 to the registers 11. The first cycles of step 106 may typically start as soon as the corresponding first operands are available on the registers 11 for the computing operations. This cascade implementation of the operations gives the system its asynchronous nature.

In some embodiments, the ALU 9 executes (step 106) all of the elementary computing operations of the processing operation during consecutive computing cycles. The ALU 9 does not perform any memory access operations during these computing cycles. The implementation of the computing operations may thus be particularly fast. The ALU 9, during such cycles, is relieved from any memory access operation. Furthermore, from the point of view of the ALU 9 performing the computing operations, the way in which the operands are obtained is similar to a call to memory 13, but the operands are obtained more quickly and independently of the memory interface 15, since the operands are in practice read directly from the registers 11. The memory access operations are implemented by another ALU (different from the one performing the computing operations). At least during a process, each ALU 9 has a fixed function: either implementing the computing operations, or implementing the memory access operations. This assignment of a fixed function to each ALU 9 may be modified at the end of the implementation of the process in order to give the computing device flexibility. However, this often involves accordingly adapting the addressing path. In the preferred embodiments, the function of each ALU 9 is therefore fixed from one process to another: the ALUs are specialized.

The methods and the variants described above may take the form of a computing device, including a processor or a set of processors, designed to implement such a method.

The disclosure is not limited to the examples of methods and devices described above, only by way of example, but rather incorporates all variants that a person skilled in the art will be able to contemplate within the scope of protection that is sought. The disclosure also relates to a set of processor-implementable machine instructions for obtaining such a computing device, such as a processor or a set of processors, to the implementation of such a set of machine instructions on a processor, to the processor architecture management method implemented by the processor, to the computer program comprising the corresponding set of machine instructions, and to the recording medium on which such a set of machine instructions is computationally recorded.

The following pages of the description of the original document give some exemplary implementations in the form of computer pseudocode.

Example of a processing operation to be performed in the form of ten additions, in the form of computer pseudocode:

IntA[10], B[10], C[10]
for (i=0; i<10; i++)
{
C[i] = A[i] + B[i];
}

Example of conventional instructions for performing a processing operation consisting of ten additions, in the form of computer pseudocode:

@A, @B, @C
Addr0 = @A
Addr1 = @B
Addr2 = @C
LOOP:
Load Addr0 → reg0
Load Addr1 → reg1
reg2 = reg0 + reg1
Store addr2 → reg2
Addr0 = Addr0 + 1
Addr1 = Addr1 + 1
Addr2 = Addr2 + 1
GOTO LOOP (10x)

Example of instructions for performing a processing operation consisting of ten additions according to one embodiment in which the addressing instructions and the computing instructions are distinguished from one another, in the form of computer pseudocode:

//step 101//
Addr = @A
LOOP
LoadAddr
Addr = addr + 1
GOTO LOOP (10x)
//step 102//
Addr = @B
LOOP
LoadAddr
Addr = addr + 1
GOTO LOOP (10x)
//step 106//
LOOP
c = a + b
GOTO LOOP (10x)
//step 108//
Addr = @C
LOOP
LoadAddr
Addr = addr + 1
GOTO LOOP (10x)

1. A data processing method, able to be broken down into a set of elementary operations to be performed, implemented by a computing device, said device comprising:
a control unit;
at least one arithmetic logic unit;
a set of registers able to supply data forming an operand to the inputs of said first arithmetic logic unit and able to be supplied with data from the outputs of said arithmetic logic unit;
a memory;
a memory interface by way of which data are transmitted and routed between the registers and the memory;
said method comprising:
a) obtaining the memory addresses of each of the data absent from the registers and forming an operand for at least one of said elementary operations to be performed and;
b) reading each of said data from memory by way of the obtained memory addresses in order to load them into the registers via the memory interface;
c) transmitting an instruction to execute computing operations from the control unit to said first arithmetic logic unit, said instruction not containing any addressing instruction;
d) upon receiving said instruction to execute computing operations, and as soon as the corresponding operands are available on the registers, executing all of said elementary operations by way of said first arithmetic logic unit receiving, at input, each of the operands from the registers;
e) storing the data forming results of the processing operation on the registers at output of said first arithmetic logic unit;
f) obtaining a memory address for each of the data forming a result of the processing operation;
g) writing each of the data forming a result of the processing operation from the registers to memory for storage and via the memory interface, by way of the obtained memory addresses.

2. The method as claimed in claim 1, wherein said first arithmetic logic unit executes all of the elementary computing operations of the processing operation during consecutive computing cycles, said first arithmetic logic unit not performing any memory access operations during said computing cycles.

3. The method as claimed in claim 1, wherein at least one of the following steps comprises an iterative loop:
a) obtaining the memory addresses of each of the data absent from the registers and forming an operand for at least one of said elementary operations to be performed and;
d) upon receiving said instruction to execute computing operations, executing all of said elementary operations by way of said arithmetic logic unit receiving, at input, each of the operands from the registers;
f) obtaining a memory address for each of the data forming a result of the processing operation.

4. The method as claimed in claim 1, wherein the device furthermore comprises at least one additional arithmetic logic unit separate from the first arithmetic logic unit executing all of said elementary operations, the additional arithmetic logic unit implementing the following:
a) obtaining the memory addresses of each of the data absent from the registers and forming an operand for at least one of said elementary operations to be performed; and
b) reading each of said data from memory by way of the obtained memory addresses in order to load them into the registers via the memory interface.

5. A computing device for processing data, said processing operation being able to be broken down into a set of elementary operations to be performed, said device comprising:
a control unit;
at least one first arithmetic logic unit from among a plurality;
a set of registers able to supply data forming an operand to the inputs of said arithmetic logic units and able to be supplied with data from the outputs of said arithmetic logic units;
a memory;
a memory interface by way of which data are transmitted and routed between the registers and the memory;
said computing device being configured so as to:
a) obtain the memory addresses of each of the data absent from the registers and forming an operand for at least one of said elementary operations to be performed and;
b) read each of said data from memory by way of the obtained memory addresses in order to load them into the registers via the memory interface;
c) transmit an instruction to execute computing operations from the control unit to said first arithmetic logic unit, said instruction not containing any addressing instruction;
d) upon receiving said instruction to execute computing operations, and as soon as the operands are available on the registers, execute all of said elementary operations by way of said first arithmetic logic unit receiving, at input, each of the operands from the registers;
e) store the data forming results of the processing operation on the registers at output of said first arithmetic logic unit;
f) obtain a memory address for each of the data forming a result of the processing operation;
g) write each of the data forming a result of the processing operation from the registers to memory for storage and via the memory interface, by way of the obtained memory addresses.

6. A set of machine instructions for implementing the method as claimed in claim 1 when this program is executed by a computing device including at least one processor.

7. A non-transitory computer program comprising instructions for implementing the method as claimed in claim 1 when this program is executed by a computing device including at least one processor.

8. A non-transient computer-readable recording medium on which there is recorded a program for implementing the method as claimed in claim 1 when this program is executed by a processor.
